(19) United States
(12) Patent Application Publication
(10) Pub. No.: US 2020/0103708 A1
(43) Pub. Date: Apr. 2, 2020

(54) DISPLAY DEVICE

(71) Applicant: SAMSUNG DISPLAY CO., LTD., Yongin-si (KR)

(72) Inventors: Wonchul LEE, Seoul (KR); Jinhyuk PARK, Hwaseong-si (KR); Jeongmin SEO, Yongin-si (KR)

(21) Appl. No.: 16/531,310

(22) Filed: Aug. 5, 2019

(30) Foreign Application Priority Data
Sep. 28, 2018 (KR) 10-2018-0115620

(51) Int. Cl. G02F 1/1335; G02F 1/1333

(52) U.S. Cl. CPC G02F 1/133608; G02F 1/133606; G02F 1/133603; G02F 2001/133317; G02F 2001/133614; G02F 1/133308

(57) ABSTRACT

A display device includes a display panel, and a backlight unit disposed below the display panel. The backlight unit includes a bottom cover including a bottom portion and a side wall protruding from the bottom portion, a light source accommodated in the bottom cover, a middle mold supported by the bottom cover, where the middle mold includes a seating portion and an elastic portion mounted on the seating portion, a diffusion plate supported by the elastic portion, and an optical sheet disposed on the elastic portion. The seating portion and the elastic portion include different materials from each other. The elastic portion has a side end portion that defines a depression for accommodating an end portion of the diffusion plate.

### CROSS-REFERENCE TO RELATED APPLICATION

This application claims priority to Korean Patent Application No. 10-2018-0115620, filed on Sep. 28, 2018, and all the benefits accruing therefrom under 35 U.S.C. § 119, the content of which in its entirety is herein incorporated by reference.

### BACKGROUND

### 1. Technical Field

Exemplary embodiments of the invention relate to a display device that includes a backlight unit including a glass diffusion plate, and more particularly, to a display device that substantially minimizes a bezel width and prevents movement and cracking of a glass diffusion plate.

### 2. Discussion of Related Art

A display device may be classified into liquid crystal display (“LCD”) devices, organic light emitting diode (“OLED”) display devices, plasma display panel (“PDP”) display devices, and electrophoretic display devices based on a light emitting scheme thereof.

Such an LCD device includes an LCD panel for displaying video data and a backlight unit for emitting light to the LCD panel. The LCD panel and the backlight unit are assembled in a stacked state, and are implemented as a liquid crystal module. The liquid crystal module further includes a guide/case member for securing the LCD panel and the backlight unit, and a driving circuit board of the LCD panel.

Backlight units are roughly classified into a direct type and an edge type. The direct type backlight unit has a structure in which a plurality of light sources are disposed below an LCD panel, and the edge type backlight unit has a structure in which a light source is disposed so as to oppose a side surface of a light guide plate, and a plurality of optical sheets are disposed between an LCD panel and the light guide plate.

Meanwhile, in recent years, glass has been adopted as a material for a diffusion plate in the direct type backlight unit, but such a glass diffusion plate is heavy and prone to breakage.

In addition, since a glass substrate is rigid, it is difficult to deform the display device. Recently, display devices using a flexible substrate that is light, strong against impact, and easy to deform are being developed.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Exemplary embodiments of the invention may be directed to a display device including a middle mold that employs an opaque elastic portion so that it is capable of substantially preventing light leakage and easily securing a light diffusion plate to facilitate and improve assembly.

In addition, exemplary embodiments of the invention may be directed to a display device including an elastic portion that is defined with a guide depression for stably mounting an optical sheet on four surfaces of the elastic portion, so that it is capable of substantially preventing movement of the optical sheet and also scratch of the optical sheet that may occur when in contact with a diffusion plate.

In particular, exemplary embodiments of the invention may be directed to a display device capable of substantially preventing an optical sheet from damaging a surface of a diffusion plate that includes a light conversion layer.

According to an exemplary embodiment, a display device includes a display panel and a backlight unit disposed below the display panel. The backlight unit includes a bottom cover including a bottom portion and a side wall protruding from the bottom portion, a light source accommodated in the bottom cover, a middle mold supported by the bottom cover, where the middle mold includes a seating portion and an elastic portion mounted on the seating portion, a diffusion plate supported by the elastic portion, and an optical sheet disposed on the elastic portion. The seating portion and the elastic portion include different materials from each other. The elastic portion has a side end portion that defines a depression for accommodating an end portion of the diffusion plate.

In an exemplary embodiment, the side end portion may surround a side surface, an upper surface, and a lower surface of the diffusion plate.

In an exemplary embodiment, a thickness of the side end portion of the elastic portion may decrease along a direction from the accommodated end portion of the diffusion plate toward a center portion of the diffusion plate.

In an exemplary embodiment, the elastic portion may include a coupling projection to be inserted into the seating portion, and the seating portion may have a coupling depression for accommodating the coupling projection.

In an exemplary embodiment, a width of the coupling projection and a width of the coupling depression may decrease along a thickness direction from a lower surface of the elastic portion toward an upper surface of the seating portion.

In an exemplary embodiment, the elastic portion may be spaced apart from each of the end portion of the diffusion plate and an end portion of the optical sheet in at least one of a first direction and a second direction different from the first direction.

In an exemplary embodiment, a distance between the elastic portion and the diffusion plate may be different from a distance between the elastic portion and the optical sheet.

In an exemplary embodiment, the diffusion plate may be spaced apart from the display panel by the elastic portion in a third direction.

In an exemplary embodiment, the elastic portion may define a guide depression for accommodating a part of the optical sheet.

In an exemplary embodiment, a thickness of the side end portion of the elastic portion may decrease along a direction from the accommodated end portion of the diffusion plate toward a center portion of the diffusion plate in an area corresponding to the guide depression.

In an exemplary embodiment, the optical sheet may include a protruding portion disposed at the guide depression.

In an exemplary embodiment, the elastic portion may include a projection disposed on the guide depression, and the protruding portion of the optical sheet may define one of a through hole and a cutout portion for accommodating the projection.

In an exemplary embodiment, the display device may further include an adhesive tape that covers the guide depression of the elastic portion.

In an exemplary embodiment, the elastic portion may define a step depression for accommodating the adhesive tape.

In an exemplary embodiment, a thickness of the adhesive tape may be substantially equal to a thickness of the step depression.

In an exemplary embodiment, the elastic portion may further include a buffer portion having a hollow structure.

According to an exemplary embodiment, a display device includes a display panel having a display area and a non-display area, and a backlight unit disposed below the display panel. The backlight unit includes a bottom cover including a bottom portion and a side wall protruding from the bottom portion, a light source accommodated in the bottom cover, a middle mold supported by the bottom cover, wherein the middle mold includes a seating portion and an elastic portion mounted on the seating portion, a diffusion plate supported by the elastic portion, and an optical sheet disposed on the elastic portion. The elastic portion has a guide depression for accommodating a part of the optical sheet. The optical sheet includes a protruding portion disposed at the guide depression.

In an exemplary embodiment, the elastic portion may include a projection disposed on the guide depression, and the protruding portion of the optical sheet may define one of a through hole and a cutout portion for accommodating the projection.

In an exemplary embodiment, the display device may further include an adhesive tape that covers the guide depression of the elastic portion.

In an exemplary embodiment, the elastic portion may define a step depression for accommodating the adhesive tape.

In an exemplary embodiment, a thickness of the adhesive tape may be substantially equal to a thickness of the step depression.

In an exemplary embodiment, the diffusion plate may include a glass plate, a wavelength conversion layer disposed at an upper surface of the glass plate, a passivation layer disposed on the wavelength conversion layer, and a diffusion pattern disposed at a lower surface of the glass plate.

In an exemplary embodiment, the optical sheet may have a thickness less than a thickness of the diffusion plate.

In an exemplary embodiment, the optical sheet may have a thickness greater than a thickness of the diffusion plate at an area corresponding to the protruding portion.

In an exemplary embodiment, the optical sheet may contact the diffusion plate at the display area.

The foregoing is illustrative only and is not intended to be in any way limiting. In addition to the illustrative aspects, exemplary embodiments and features described above, further aspects, exemplary embodiments and features will become apparent by reference to the drawings and the following detailed description.

### BRIEF DESCRIPTION OF THE DRAWINGS

A more complete appreciation of the present invention will become more apparent by describing in detail exemplary embodiments thereof with reference to the accompanying drawings, wherein:

FIG. 1 is an exploded perspective view illustrating an exemplary embodiment of a display device;

FIG. 2 is a cross-sectional view taken along line I-I′ in FIG. 1;

FIG. 3 is a cross-sectional view taken along line II-II′ in FIG. 1;

FIG. 4 is a cross-sectional view illustrating another exemplary embodiment of a display device including a middle mold;

FIG. 5 is an exploded perspective view illustrating a coupling depression and a coupling projection disposed at an edge of a middle mold;

FIG. 6 is a plan view illustrating an optical sheet disposed on a middle mold;

FIGS. 7A to 7D are partial perspective views illustrating various exemplary embodiments of a disposition structure of a middle mold and an optical sheet in FIG. 6;

FIGS. 8A to 8C are cross-sectional views illustrating various exemplary embodiments of an elastic portion that supports a diffusion plate;

FIGS. 9A and 9B are cross-sectional views illustrating an exemplary embodiment of an elastic portion that includes a buffer portion having a hollow structure; and

FIGS. 10A to 10C are cross-sectional views illustrating an exemplary embodiment of a diffusion plate.

### DETAILED DESCRIPTION

Exemplary embodiments will now be described more fully hereinafter with reference to the accompanying drawings. Although the invention may be modified in various manners and have several exemplary embodiments, exemplary embodiments are illustrated in the accompanying drawings and will be mainly described in the specification. However, the scope of the invention is not limited to the exemplary embodiments and should be construed as including all the changes, equivalents and substitutions included in the spirit and scope of the present invention.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper” and the like, may be used herein for ease of description to describe the relations between one element or component and another element or component as illustrated in the drawings. It will be understood that the spatially relative terms are intended to encompass different orientations of the device in use or operation, in addition to the orientation illustrated in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined at the present specification.

Some of the parts which are not associated with the description may not be provided in order to specifically describe exemplary embodiments of the invention and like reference numerals refer to like elements throughout the specification.

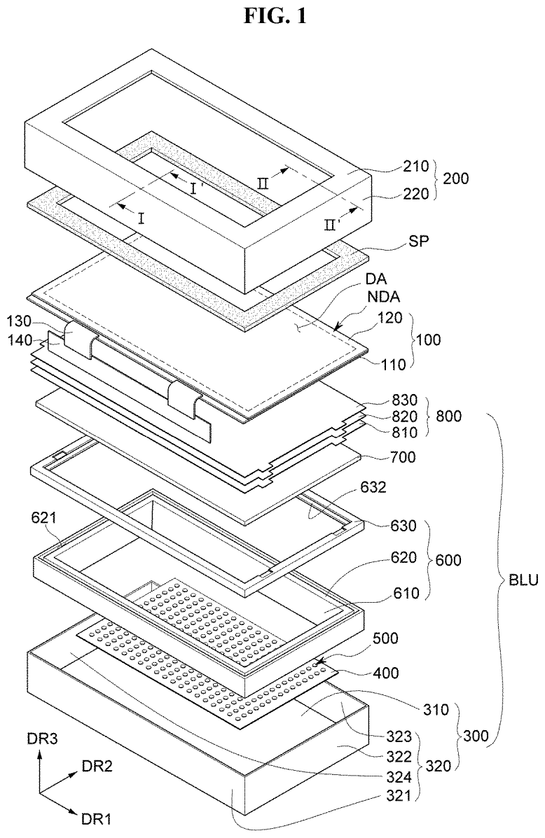

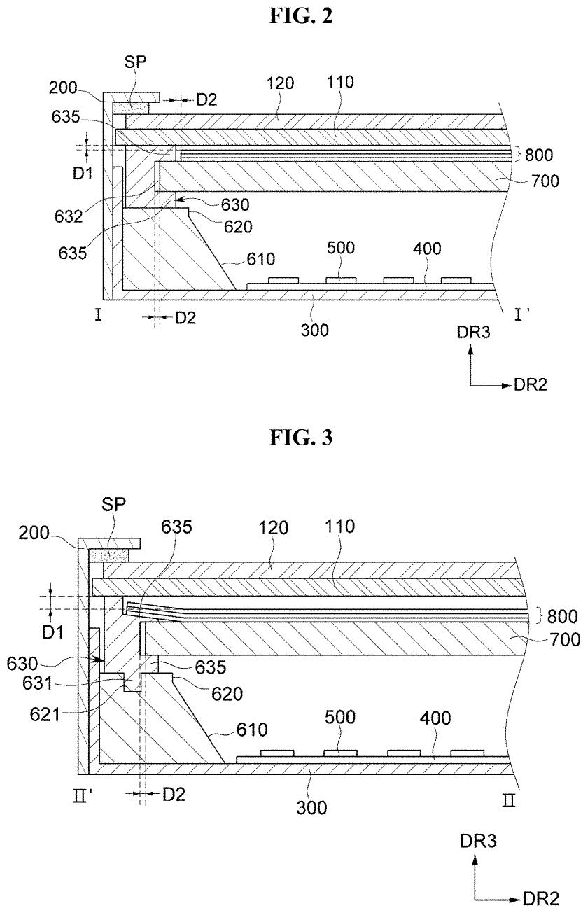

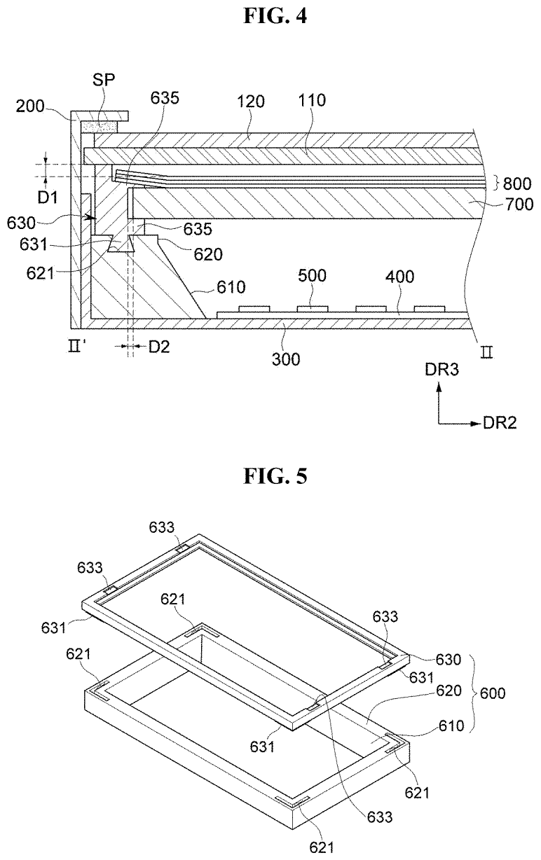

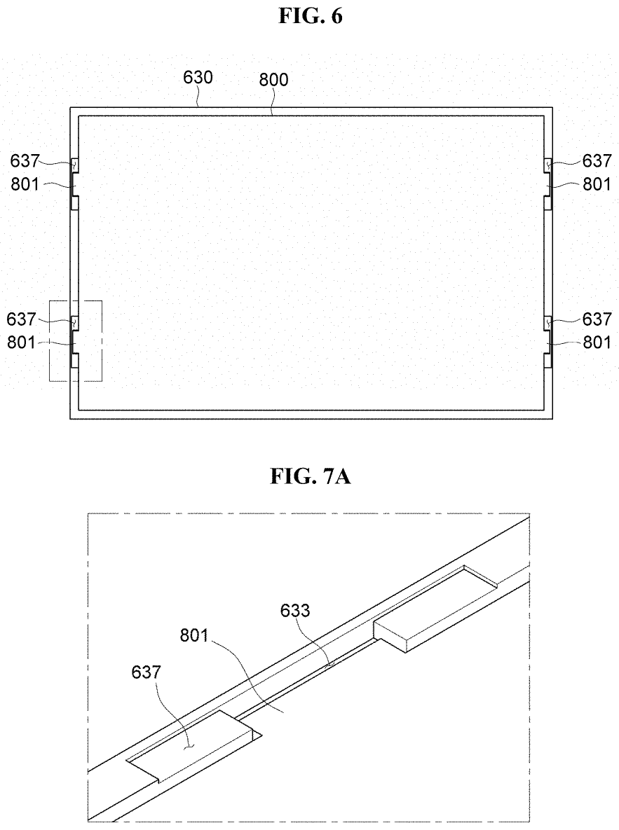

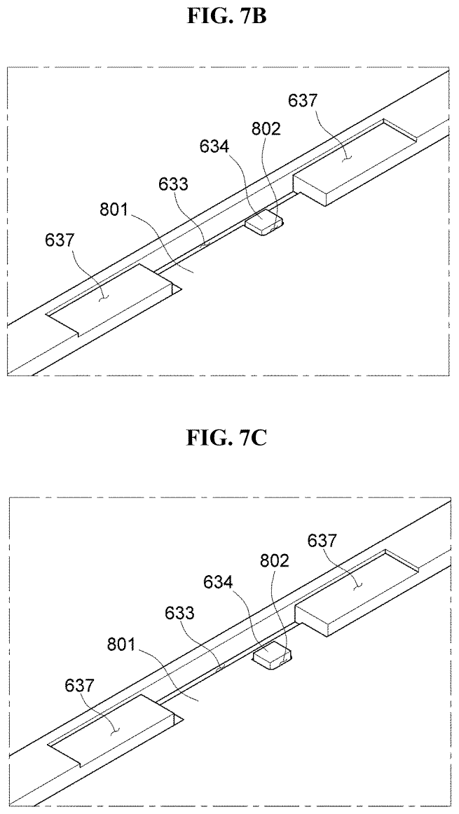

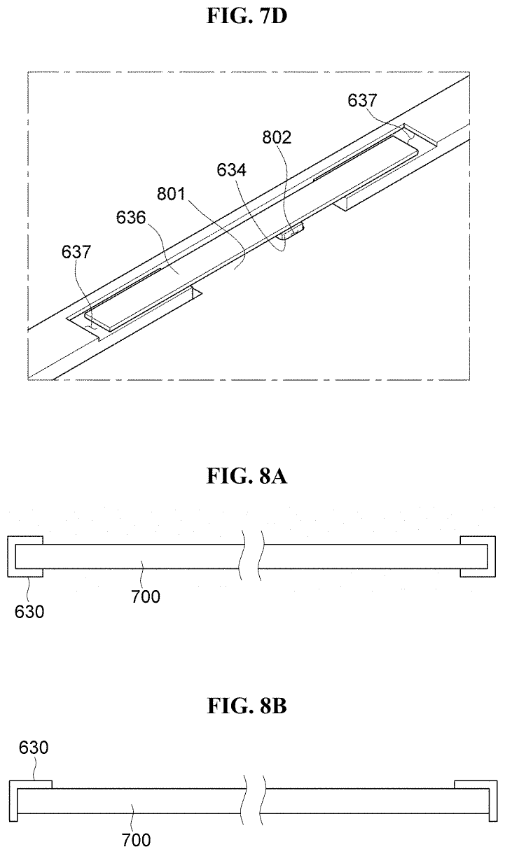

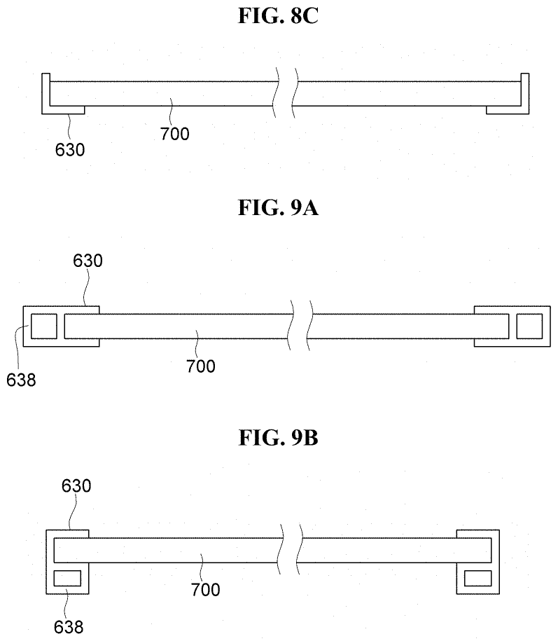

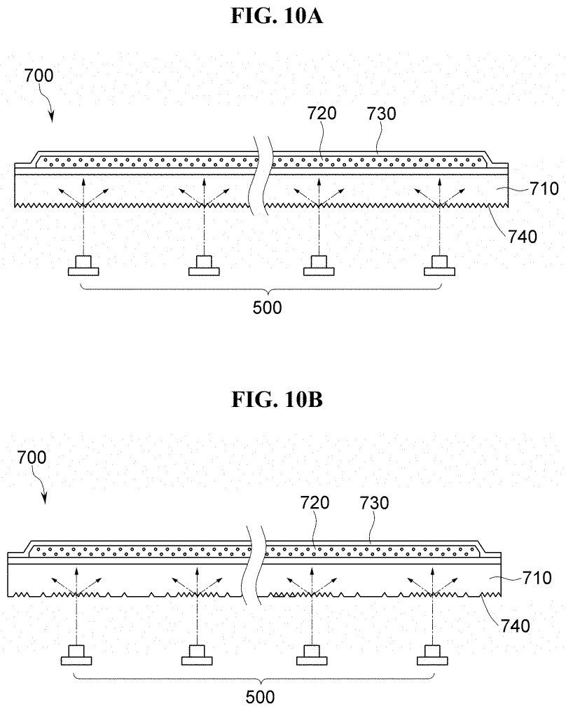

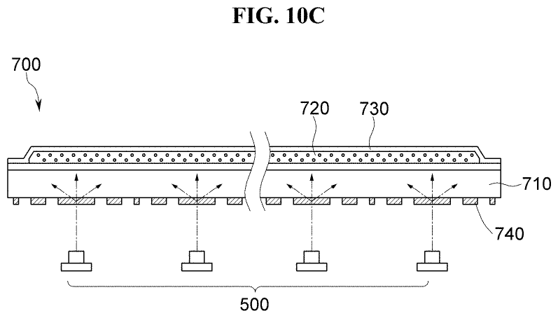

FIG. 1 is an exploded perspective view illustrating an exemplary embodiment of a display device, FIG. 2 is a cross-sectional view taken along line I-I′ in FIG. 1, FIG. 3 is a cross-sectional view taken along line II-II′ in FIG. 1, FIG. 4 is a cross-sectional view illustrating another exemplary embodiment of a display device including a middle mold, FIG. 5 is an exploded perspective view illustrating a coupling depression and a coupling projection disposed at an edge of a middle mold, FIG. 6 is a plan view illustrating an optical sheet disposed on a middle mold, FIGS. 7A to 7D are partial perspective views illustrating various exemplary embodiments of an disposition structure of a middle mold and an optical sheet in FIG. 6, FIGS. 8A to 8C are cross-sectional views illustrating various exemplary embodiments of an elastic portion that supports a diffusion plate, FIGS. 9A and 9B are cross-sectional views illustrating an exemplary embodiment of an elastic portion that includes a buffer portion having a hollow structure, and FIGS. 10A to 10C are cross-sectional views illustrating an exemplary embodiment of a diffusion plate.

Referring to FIGS. 1 to 3, a display device may include a display panel 100, a top cover 200, and a backlight unit BLU.

The display panel 100 receives light from the backlight unit BLU and displays images. The display panel 100 is a light-receiving display panel such as a liquid crystal display (“LCD”) panel. Hereinafter, the display panel 100 will be exemplarily described as an LCD panel.

The display panel 100 is divided into a display area DA for displaying images and a non-display area NDA that surrounds the display area DA and does not display images.

The display panel 100 includes a first substrate 110, a second substrate 120 that opposes the first substrate 110, and a liquid crystal layer disposed between the two substrates.

The first substrate 110 may include gate lines, data lines, thin film transistors, and pixel electrodes. The gate lines and the data lines may be insulated from each other and intersect each other. The thin film transistor, which is a three-terminal device, is connected to one of the gate lines, one of the data lines, and one of the pixel electrodes. A data voltage applied to the data line may be applied to the pixel electrode according to a signal applied to the gate line.

The second substrate 120 may be disposed facing the first substrate 110 with respect to the liquid crystal layer interposed therebetween. The second substrate 120 may include a color filter and a common electrode. However, the invention is not limited thereto. In an alternative exemplary embodiment, at least one of the color filter and the common electrode may be disposed at the first substrate 110. In an alternative exemplary embodiment, the second substrate 120 may be omitted, and a liquid crystal layer encapsulated by a color filter, a common electrode, and an insulating layer may be disposed on the first substrate 110.

The second substrate 120 may have a size less than a size of the first substrate 110 in a plan view. A portion of the first substrate 110 may be exposed outside the second substrate 120 in the plan view.

The liquid crystal layer may include a plurality of liquid crystal molecules that change their alignment state in accordance with an electric field provided between the first substrate 110 and the second substrate 120.

In FIG. 1, the display panel 100 is depicted as having a quadrangular shape in a plan view. A long side of the display panel 100 may extend in a first direction DR1, and a short side of the display panel 100 may extend in a second direction DR2. A thickness direction of the display panel 100 may be defined as a third direction DR3.

The display device may further include a flexible printed circuit board (“FPCB”) 130 and a printed circuit board (“PCB”) 140.

The FPCB 130 is bent and electrically connects the display panel 100 and the PCB 140. One end portion of the FPCB 130 may be connected to the surface of the first substrate 110 that is exposed outside the second substrate 120, and another end portion of the FPCB 130 may be connected to the PCB 140. The FPCB 130 may be provided in plural. The plurality of FPCBs 130 may be spaced apart from each other along the first direction DR1. In FIG. 1, two FPCBs 130 are illustratively provided.

The PCB 140 may be coupled to the backlight unit BLU. The PCB 140 may output a signal to the display panel 100 or receive a signal from the display panel 100 through the FPCB 130.

In an exemplary embodiment, an integrated circuit (“IC”) chip may be mounted at the FPCB 130. A data driving chip may be provided at the IC chip. The FPCB 130 may be a tape carrier package (“TCP”) or a chip on film (“COF”). However, the invention is not limited thereto, and the IC chip may be mounted directly on the surface of the first substrate 110.

A top cover 200 is spaced apart from the display panel 100 by a spacer SP, covers an edge of the display panel 100, and is coupled to the display panel 100 and the backlight unit BLU. The top cover 200 defines an opening that exposes the display area DA of the display panel 100.

The top cover 200 may include a front cover 210 and a side cover 220. The front cover 210 may cover an edge of an upper surface of the display panel 100. The side cover 220 may cover side surfaces of the display panel 100 and the backlight unit BLU.

The backlight unit BLU is disposed below the display panel 100 to provide light to the display panel 100.

The backlight unit BLU may include a bottom cover 300, a reflective sheet 400, light sources 500, a middle mold 600, a diffusion plate 700, and optical sheets 800.

Hereinafter, the backlight unit BLU will be described in detail with reference to FIGS. 1 to 3.

The bottom cover 300 may include a bottom portion 310 and a side wall 320.

The bottom portion 310 may be flat. The bottom portion 310 may be provided in a quadrangular shape in a plan view.

The side wall 320 may protrude and extend from an edge of the bottom portion 310. The side wall 320 may include first, second, third, and fourth sidewalls 321, 322, 323, and 324. The first, second, third, and fourth sidewalls 321, 322, 323, and 324 may be connected to four sides of the bottom portion 310, respectively.

The first sidewall 321 may be parallel to and mostly adjacent to the side of the display panel 100 to which the FPCB 130 is attached, among the sidewalls 321, 322, 323, and 324.

A portion of the first sidewall 321 may be disposed inclined with respect to the bottom portion 310. An angle defined between the portion of the first sidewall 321 (e.g., inner portion) and the bottom portion 310 may be an obtuse angle.

The second, third, and fourth sidewalls 322, 323, and 324 may extend from the bottom portion 310 in the third direction DR3.

The reflective sheet 400 is disposed on the bottom portion 310 and below the light sources 500. The reflective sheet 400 reflects most of light incident thereto.

The backlight unit BLU may further include a driving substrate (not illustrated). The driving substrate (not illustrated) may be disposed between the bottom portion 310 and the reflective sheet 400. The driving substrate (not illustrated) may be electrically connected to the light sources 500 to provide driving signals to the light sources 500. The driving substrate (not illustrated) may be provided in plural.

The light sources 500 are accommodated in the bottom cover 300. The light sources 500 include a plurality of light sources, and are disposed on the reflective sheet 400. The light sources 500 are provided as a direct type, and light emitted from the light sources 500 is directly incident to the diffusion plate 700 without passing through a separate light guide plate.

In an exemplary embodiment, each of the light sources 500 may be a cold cathode fluorescent lamp (“CCFL”), a flat fluorescent lamp (“FFL”), or a light emitting diode (“LED”). Hereinafter, it is exemplarily described that each of the light sources 500 is an LED.

The light sources 500 may include white light sources that emit white light. However, the invention is not limited thereto. In an exemplary embodiment, the light sources 500 may include a red-light source that emits red light, a green-light source that emits green light, and a blue-light source that emits blue light.

The middle mold 600 includes a slope portion 610, a seating portion 620, and an elastic portion 630.

The slope portion 610 and the seating portion 620 may include materials different from each other.

The slope portion 610 and the seating portion 620 may include a metal or plastic material. The seating portion 620 and the elastic portion 630 comprise different materials. In an exemplary embodiment, the elastic portion 630 includes a silicon rubber compound (for example, silane) or a rubber material that has elasticity.

The slope portion 610 extends from an end portion of the seating portion 620 toward the reflective sheet 400 and the light sources 500. The slope portion 610 makes an obtuse angle with respect to the seating portion 620.

Although not illustrated, at least a portion of the reflective sheet 400 may be disposed on the slope portion 610 so as to utilize the light emitted from the light source 500 efficiently.

The seating portion 620 may be parallel to the bottom portion 310. The elastic portion 630 is mounted on an upper surface of the seating portion 620, and the seating portion 620 supports the elastic portion 630. The elastic portion 630 may be attached to the seating portion 620 by an adhesive force of the elastic portion 630 itself.

Referring to FIG. 3, the elastic portion 630 includes a coupling projection 631 that may be engaged with a coupling depression 621 of the seating portion 620 in an interlocking manner. The seating portion 620 defines the coupling depression 621 that may accommodate a part of the elastic portion 630, i.e., the coupling projection 631.

In an alternative exemplary embodiment, although not illustrated in the drawings, the seating portion 620 may include a coupling projection which may be inserted to a part of the elastic portion 630, and the elastic portion 630 may define a coupling depression that may be engaged with the coupling projection of the seating portion 620 in an interlocking manner.

Referring to FIG. 1, each of the coupling projection 631 and the coupling depression 621 may have a shape of a rail around the middle mold 600.

The coupling depression 621 and the coupling projection 631 may be located on at least a portion of the seating portion 620 and the elastic portion 630, respectively. Referring to FIG. 5, the coupling depression 621 and the coupling projection 631 are located at a corner portion of the seating portion 620 and a corner portion of the elastic portion 630, respectively.

Referring to FIG. 4, each of the coupling depression 621 and the coupling projection 631 may have a width that changes along a vertical direction so as to be engaged with each other with an enhanced coupling force. The coupling projection 631 has a greater width, as further away from a lower surface of the elastic portion 630, and the coupling depression 621 has a greater width toward an upper surface of the seating portion 620. That is, the width of the coupling projection 631 in the second direction DR2 decreases along the thickness direction from the lower surface of the elastic portion 630 toward the upper surface of the seating portion 620, and the coupling depression 621 in the second direction DR2 also decreases along the thickness direction from the lower surface of the elastic portion 630 toward the upper surface of the seating portion 620. Here, the thickness direction from a lower surface of the elastic portion toward an upper surface of the seating portion corresponds to the third direction DR3.

Referring to FIGS. 1 to 4, the elastic portion 630 may extend along at least one of the first direction DR1 and the second direction DR2, and may support edge portions of four sides of the diffusion plate 700 and four sides of the optical sheet 800. In addition, the elastic portion 630 extends from the seating portion 620 in the third direction DR3. The elastic portion 630 separates the diffusion plate 700 and the optical sheet 800 from the substrate 100 at a distance D1 in the third direction DR3. Accordingly, a thickness, in the third direction DR3, of the elastic portion 630 is greater than a sum of a thickness of the diffusion plate 700 and a thickness of the optical sheet 800.

The elastic portion 630 defines a depression 632 that accommodates an edge portion of the diffusion plate 700. The depression 632 of the elastic portion 630 extends around the middle mold 600 and accommodates an end portion (e.g., edges) of the diffusion plate 700. The elastic portion 630 may be separated from each end portion of the diffusion plate 700 and the optical sheet 800 at a distance D2 in the first direction DR1 or the second direction DR2. That is, the elastic portion 630 has a thickness in the third direction DR3 greater than a thickness of the diffusion plate 700 so that the end portion of the diffusion plate 700 is inserted in the elastic portion 630. Referring to FIG. 2, the distance D2 between the elastic portion 630 and the diffusion plate 700 is substantially equal to the distance between the elastic portion 630 and the optical sheet 800. However, the invention is not limited thereto, and the distances may be different from each other.

Due to the distances D1 and D2 secured for the elastic portion 630, the diffusion plate 700, and the optical sheet 800, expansion effects in the first, second, and third directions DR1, DR2, and DR3 due to a difference in thermal expansion coefficient between the diffusion plate 700 and the elastic portion 630 may be reduced.

Referring to FIGS. 3 and 4, the elastic portion 630 has a side end portion 635 that defines the depression 632 for accommodating the diffusion plate 700. Referring to FIG. 2, the side end portion 635 has a constant thickness in the third direction DR3 except an area corresponding to a guide depression 633 (See FIG. 5) of the elastic portion 630. Although not illustrated, the side end portion 635 may have a smaller thickness toward a center portion of the diffusion plate 700 (i.e., the thickness of the side end portion 635 may decrease along a direction from the end portion of the diffusion plate 700 toward the center portion of the diffusion plate 700. Here, the direction from the end portion toward the center portion of the diffusion plate corresponds to the second direction DR2.) except the area corresponding to the guide depression 633 of the elastic portion 630.

Referring to FIGS. 3 and 4, the side end portion 635 has a smaller thickness toward the center portion of the diffusion plate 700 (i.e., the thickness of the side end portion 635 may decrease along a direction from the end portion of the diffusion plate 700 toward the center portion of the diffusion plate 700. Here, the direction from the end portion toward the center portion of the diffusion plate corresponds to the second direction DR2.) and contacts the diffusion plate 700 in the area corresponding to the guide depression 633. The optical film 800 is disposed in close contact with an upper portion of the elastic portion 630 and an upper surface of the diffusion plate 700 due to a structure of the side end portion 635 that is inclined. Accordingly, a phenomenon in which the optical film 800 is lifted at the side end portion 635 without attached to the elastic portion 630 may be substantially prevented.

The elastic portion 630 includes an opaque material and substantially prevents light leakage that may be caused by light having passed through the diffusion plate 700. In specific, referring to FIGS. 1 to 4, the elastic portion 630, in more specific, the side end portion 635 of the elastic portion 630 surrounds three surfaces (e.g., a side surface, an upper surface, and a lower surface) of an end portion (e.g., edges) of the diffusion plate 700. Accordingly, the elastic portion 630 substantially prevents light leakage by blocking light that is incident between the diffusion plate 700 and the seating portion 620 and blocking light that is emitted toward the end portion of the diffusion plate 700 of the light that has passed through the diffusion plate 700.

Referring to FIGS. 8A, 8B, and 8C, the elastic portion 630 may surround three surfaces (e.g., the side surface, the upper surface, and the lower surface) of the end portion of the diffusion plate 700. In other exemplary embodiments, the elastic portion 630 may surround two surfaces (e.g., the side surface and the upper surface or the side surface and the lower surface) of the end portion of the diffusion plate 700, and thus light leakage phenomenon that may be caused by light having passed through the diffusion plate 700 may be substantially prevented.

Referring to FIGS. 7A to 7C, the guide depression 633 for accommodating a protruding portion 801 of the optical sheet 800 is defined at the elastic portion 630, and more specifically, at an upper portion of the elastic portion 630. In addition, the elastic portion 630 may further include, at a bottom portion of the guide depression 633, a projection 634 that is to be inserted to a through hole or a cutout portion 802 defined at the protruding portion 801 of the optical sheet 800. It is depicted in FIGS. 1, 5, and 6 that two guide depressions 633 are located on a left side of the elastic portion 630, and another two guide depressions 633 are located on a right side of the elastic portion 630. However, the invention is not limited thereto, and in another exemplary embodiment, one or more guide depressions 633 may be located on each of upper and lower sides of the elastic portion 630.

Referring to FIG. 7D, an adhesive tape 636 for covering the guide depression 633 may be further provided on the elastic portion 630. The adhesive tape 636 includes an adhesive layer on at least one surface of the adhesive tape 636. In the case that the adhesive tape 636 includes the adhesive layer only at a lower surface thereof, the adhesive tape 636 is attached to an upper portion of the elastic portion 630. In the case that the adhesive tape 636 includes the adhesive layer at both opposite surfaces thereof, a lower surface of the adhesive tape 636 is attached to the upper portion of the elastic portion 630, and an upper surface of the adhesive tape 636 is attached to the display panel.

As such, the guide depression 633 and the adhesive tape 636 reduce an amount of movement of the optical sheet 800, and thus substantially prevent scratches that may be caused by friction with a wavelength conversion layer 720, to be described below, of the diffusion plate 700.

Referring again to FIGS. 7A and 7D, the elastic portion 630 may further have a step depression 637 for accommodating the adhesive tape 636 on an upper surface of the elastic portion 630. The step depression 637 may have a thickness substantially the same as a thickness of the adhesive tape 636. The step depression 637 may reduce an assembly tolerance of the display module that may be caused because of the thickness of the adhesive tape 636.

Referring to FIGS. 9A and 9B, the elastic portion 630 may further include a buffer portion 638 having a hollow structure that forms an air gap in at least one of a side wall and a lower portion of the elastic portion 630. The buffer portion 638 may effectively absorb an impact that may be caused due to a change of position of the diffusion plate 700 and the substrate 100 by virtue of its hollow structure in addition to an elastic material of the elastic portion 630.

Referring to FIG. 1, at least a portion of the diffusion plate 700 may be inserted into the depression 632 of the elastic portion 630. The diffusion plate 700 serves to uniformly diffuse the light emitted from the light sources 500. That is, the diffusion plate 700 may disperse the light incident from the light sources 500 such that the light emitted from the diffusion plate 700 may be substantially prevented from being locally concentrated.

Referring to FIGS. 10A, 10B, and 10C, the diffusion plate 700 includes a glass plate 710, a wavelength conversion layer 720 disposed on an upper surface of the glass plate 710, a passivation layer 730 disposed on the wavelength conversion layer 720, and a diffusion pattern 740 disposed on a lower surface of the glass plate 710. The diffusion plate 710, the wavelength conversion layer 720, the passivation layer 730, and the diffusion pattern 740 may be integrally combined into a unitary structure.

The diffusion plate 700 serves to disperse and diffuse the light emitted from the light source 500 to improve light uniformity. The glass plate 710 may have haze properties. A haze value of the glass plate 710 may be in a range from about 30 percentages (%) to about 90%, and preferably in a range from about 50% to about 70%. If the haze value is greater than about 30%, light diffusivity may be sufficient to ensure light uniformity. In particular, if the haze value is greater than about 50%, the light diffusivity may be sufficient and thus a difference between brightness and darkness recognized on the side of a display screen may be reduced significantly. If the haze value is too great, light transmittance becomes lowered and luminance becomes lowered. From this point of view, the haze value may be about 90% or less, and more particularly, about 70% or less.

The glass plate 710 may have an overall polygonal columnar shape. A planar shape of the glass plate 710 may be quadrangular, but the invention is not limited thereto. In an exemplary embodiment, the glass plate 710 may have a quadrangular parallelepiped shape of which a planar shape is quadrangular and having an upper surface, a lower surface, and four side surfaces.

The glass plate 710 may include an inorganic material. For example, the glass plate 710 may include glass, but the invention is not limited thereto.

The wavelength conversion layer 720 is disposed on an upper surface of the glass plate 710. The wavelength conversion layer 720 converts a wavelength of at least a part of incident light. The wavelength conversion layer 720 may include wavelength converting particles.

The wavelength converting particle is a particle for converting a wavelength of a light incident thereto, and may be, for example, quantum dots (“QDs”), a fluorescent material, or a phosphorescent material. Hereinafter, a quantum dot, which is an example of the wavelength converting particle, will be described in detail. A quantum dot is a material that has a crystal structure of a few nanometers in size, includes several hundreds to thousands of atoms, and has quantum confinement effects, showing an increased band gap, due to its small size. In a case where a light having a wavelength of which an energy is higher than the bandgap is incident to the quantum dot, the quantum dot is excited by absorbing the light and falls to a ground state as emitting a light of a specific wavelength. The emitted light of the specific wavelength has an energy value corresponding to the band gap. Such a quantum dot may control the luminescence characteristics based on the quantum confinement effect by adjusting its size and composition.

The quantum dot may include, for example, at least one of group II-VI compounds, group II-V compounds, group III-VI compounds, group III-V compounds, group IV-VI compounds, group compounds, and group II-IV-VI compounds, and group II-IV-V compounds.

The quantum dot may include a core and a shell overcoating the core. The core may be or include at least one of, for example, CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe₂O₃, Fe₃O₄, Si, and Ge, but the invention is not limited thereto. The shell may be or include at least one of, for example, ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, and PbTe, but the invention is not limited thereto.

The wavelength converting particle may be provided in plural. The plurality of wavelength converting particles may convert a wavelength of a light incident thereto to a different wavelength. For example, the wavelength converting particle may include a first wavelength converting particle that converts an incident light having a specific wavelength into a light having a first wavelength and emits it and a second wavelength converting particle that converts an incident light having a specific wavelength into a light having a second wavelength and emits it. In an exemplary embodiment, a light emitted from the light source 500 and incident to the wavelength converting particle may be a light having a wavelength of blue light, the first wavelength may be a wavelength of green light, and the second wavelength may be a wavelength of red light. For example, the wavelength of blue light may be a wavelength having a peak in a range from about 420 nanometers (nm) to about 470 nm, the green wavelength may be a wavelength having a peak in a range from about 520 nm to about 570 nm, and the red wavelength may be a wavelength having a peak in a range from about 620 nm to about 670 nm. However, it should be understood that the wavelengths of blue, green, and red lights according to the invention are not limited to the above examples, and include all wavelength ranges that may be recognized in the art as blue, green, and red lights.

In the above exemplary embodiment, while the blue light that is incident to the wavelength conversion layer 720 passes through the wavelength conversion layer 720, a part of the blue light may be incident to the first wavelength converting particle, thus converted in terms of its wavelength into a green wavelength, and then emitted, another part of the blue light may be incident to the second wavelength converting particle, thus converted in terms of its wavelength into a red wavelength, and then emitted, and a remaining part of the blue light may not be incident to any of the first and second wavelength converting particles and emitted as it is without being converted in terms of its wavelength. Accordingly, the light that has passed through the wavelength conversion layer 720 may include blue, green, and red lights having wavelength thereof. If a ratio of the emitted lights having different wavelengths is appropriately adjusted, an emission light may display a white color or other colors. The lights converted by the wavelength conversion layer 720 are concentrated to a predetermined narrow wavelength range and has a sharp spectrum with a narrow-half width. Accordingly, if color is realized by filtering the light having such a spectrum with a color filter, color reproducibility may be improved.

Dissimilar to the above exemplary embodiment, a white light may be produced with an incident light having a short wavelength, e.g., an ultraviolet light, by disposing three types of wavelength converting particles that convert the incident light in terms of its wavelength into wavelengths of blue, green, and red lights, in the wavelength conversion layer 720.

The wavelength conversion layer 720 may further include scattering particles. The scattering particles may be non-quantum dot particles, which may not serve the wavelength converting function. The scattering particles scatter the incident light so that more incident light may be incident to the wavelength converting particles. In addition, the scattering particles may serve to control an emission angle of light uniformly regardless of wavelength. In specific, if a part of the incident light is incident to the wavelength converting particle, thus its wavelength being converted, and then emitted, a scattering characteristic that an emission direction is random is observed. However, if there is no scattering particle in the wavelength conversion layer 720, a light of green or red color that is emitted after colliding with the wavelength converting particle has scattering emission characteristics of random direction, while a light of a blue color that is emitted without experiencing collision with the wavelength converting particle does not have the scattering emission characteristics of random direction, such that respective emission amounts of lights having blue, green, and red colors may differ from each other according to an emission angle. Since the scattering particle gives scattering characteristics to the blue light that is emitted without experiencing collision with the wavelength converting particle, the emission angles of the blue lights may be adjusted similarly regardless of the angle. In other exemplary embodiments, the scattering particle may include, for example, TiO₂ or SiO₂.

A thickness of the wavelength conversion layer 720 may be in a range from about 10 micrometers (μm) to about 50 um. In an exemplary embodiment, the thickness of the wavelength conversion layer 720 may be about 15 μm.

The wavelength conversion layer 720 may cover most of an upper surface of the glass plate 710 and may expose a part of an edge of the glass plate 710. In other words, a side surface of the glass plate 710 may protrude with respect to a side surface of the wavelength conversion layer 720. The upper surface of the glass plate 710 exposed outside the wavelength conversion layer 720 provides a space where the side surface of the wavelength conversion layer 720 may be stably covered by the passivation layer 730.

The passivation layer 730 is disposed on the wavelength conversion layer 720. The passivation layer 730 serves to prevent permeation of moisture and/or oxygen (hereinafter, ‘moisture/oxygen’) substantially.

The passivation layer 730 may include an inorganic material. In an exemplary embodiment, the passivation layer 730 may include, for example, at least one of silicon nitride, aluminum nitride, zirconium nitride, titanium nitride, hafnium nitride, tantalum nitride, silicon oxide, aluminum oxide, titanium oxide, tin oxide, cerium oxide and silicon oxynitride, or a metal thin film in which light transmittance is secured. In an exemplary embodiment, the passivation layer 730 may include silicon nitride.

The passivation layer 730 may completely cover at least one side surface of the wavelength conversion layer 720. In an exemplary embodiment, the passivation layer 730 may completely cover all side surfaces of the wavelength conversion layer 720, but the invention is not limited thereto.

The passivation layer 730 completely overlaps the wavelength conversion layer 720, covers the upper surface of the wavelength conversion layer 720, extends further outwardly therefrom, and covers the side surface of the wavelength conversion layer 720. The passivation layer 730 may extend to an upper surface of an edge portion of the glass plate 710 exposed outside the wavelength conversion layer 720, and a part of an edge portion of the passivation layer 730 may directly contact the upper surface of the glass plate 710. In an exemplary embodiment, the side surface of the passivation layer 730 may be aligned with the side surface of the glass plate 710.

A thickness of the passivation layer 730 may be less than the thickness of the wavelength conversion layer 720. In other exemplary embodiments, the thickness of the passivation layer 730 may be in a range from about 0.1 μm to about 2 μm.

Referring to FIG. 10A, the diffusion pattern 740 may be disposed at a lower surface of the glass plate 710. The diffusion pattern 740 may diffuse the light, and thus may distribute the light uniformly on the whole. That is, since the light that has passed through the diffusion pattern 740 is emitted in a random direction, a proceeding direction of the light may be changed, and an overall uniform light distribution may be obtained regardless of arrangement of the light sources 500.

Referring to FIGS. 10B and 10C, the diffusion pattern 740 may be provided as a surface pattern of the glass plate 710 itself, or as a pattern shape provided inside the glass plate 710.

A thickness of the diffusion pattern 740 may be in a range from about 2 μm to about 5 μm, and preferably, in a range from about 2 μm to about 3 μm. In an exemplary embodiment, the thickness of the diffusion pattern 740 may be about 2 μm.

The light diffused in various directions by the diffusion pattern 740 below the glass plate 710 may be scattered and diffused once again by the wavelength conversion layer 720. Accordingly, the uniformity of light increases.

At least one end portion of the optical sheet 800 may be disposed on the elastic portion 630. That is, the optical sheet 800 may include the protruding portion 801 that is disposed at an upper surface of the elastic portion 630 and directly contacts the elastic portion 630.

Referring again to FIGS. 6, 7A, 7B, and 7C, the protruding portion 801 of the optical sheet 800 is disposed in the guide depression 633 of the elastic portion 630. In addition, the protruding portion 801 may have a through hole or a cutout portion 802 for accommodating the projection 634 disposed on a bottom portion of the guide depression 633. It is depicted in FIG. 6 that two protruding portions 801 are disposed on a left side of the optical sheet 800, and another two protruding portions 801 are disposed on a right side of the optical sheet 800. However, the invention is not limited thereto, and in an exemplary embodiment, one or more protruding portions 801 may be disposed on each of upper and lower sides of the optical sheet 800.

Since the protruding portion 801 is inserted into the guide depression 633, the optical sheet 800 may be secured without being affected by transfer processes or location changes of the display module, and thus scratches that may be generated by friction with the wavelength conversion layer 720 of the diffusion plate 700 may be substantially prevented.

Referring again to FIGS. 2, 3, and 4, another end portion of the optical sheet 800 may be spaced apart from a side wall of the elastic portion 630 by certain distances D1 and D2. In addition, the optical sheet 800 is disposed on and in directly contact with the diffusion plate 700 in the display area DA.

The optical sheet 800 has a thickness in the third direction DR3 less than a thickness of the diffusion plate 700. However, at an area corresponding to the protruding portion 801 of the optical sheet 800, the optical sheet 800 has a thickness substantially equal to or greater than the thickness of the diffusion plate 700.

Referring again to FIG. 1, the optical sheets 800 may include a diffusion sheet 810, a light collimating sheet 820, and a protective sheet 830. The diffusion sheet 810 may serve to diffuse incident light. The light collimating sheet 820 may serve to increase luminance of the diffused light. The protective sheet 830 may serve to protect the light collimating sheet 820 and secure a viewing angle. In exemplary embodiments of the invention, the optical sheets 800 are exemplarily described as including three layers (i.e., the diffusion sheet 810, the light collimating sheet 820, and the protective sheet 830). However, the invention is not limited thereto, and the optical sheets 800 may include four or more layers. In addition, the optical sheets 800 may include the light collimating sheet 820 and the protective sheet 830, without the diffusion sheet 810.

As set forth hereinabove, a display device according to one or more exemplary embodiments may provide the following effects.

An elastic portion that is opaque is employed for a middle mold, and thus light leakage may be substantially prevented and a diffusion plate may be easily secured to facilitate and improve assembly.

In addition, an optical sheet may be easily mounted by varying a thickness of the elastic portion according to the location thereof, and thus an assembly tolerance may be reduced.

In addition, a guide depression for stably mounting the optical sheet on four surfaces of the elastic portion is defined at the elastic portion, and thus movement of the optical sheet may be substantially prevented and scratch of the optical sheet that may be generated by contact with the diffusion plate may be substantially prevented.

In particular, when the diffusion plate includes a light conversion layer that includes, for example, quantum dots, the optical sheet may be substantially prevented from damaging the light diffusion layer and a passivation layer.

In addition, the middle mold is slimed down by the elastic portion, and thus a bezel width of a display device may be reduced and a display device that is strong against external impact may be provided.

While the present invention has been illustrated and described with reference to the exemplary embodiments thereof, it will be apparent to those of ordinary skill in the art that various changes in form and detail may be made thereto without departing from the spirit and scope of the present invention.

What is claimed is:

1. A display device comprising:
a display panel; and
a backlight unit disposed below the display panel,
wherein the backlight unit comprises:
a bottom cover comprising a bottom portion and a side wall which protrudes from the bottom portion;
a light source accommodated in the bottom cover;
a middle mold supported by the bottom cover, the middle mold comprising a seating portion and an elastic portion mounted on the seating portion;
a diffusion plate supported by the elastic portion; and
an optical sheet disposed on the elastic portion,
the seating portion and the elastic portion comprise different materials from each other, and
the elastic portion has a side end portion that defines a depression for accommodating an end portion of the diffusion plate.

2. The display device of claim 1, wherein the side end portion surrounds a side surface, an upper surface, and a lower surface of the diffusion plate.

3. The display device of claim 1, wherein a thickness of the side end portion of the elastic portion decreases along a direction from the accommodated end portion of the diffusion plate toward a center portion of the diffusion plate.

4. The display device of claim 1, wherein the elastic portion comprises a coupling projection to be inserted into the seating portion, and
the seating portion has a coupling depression for accommodating the coupling projection.

5. The display device of claim 4, wherein a width of the coupling projection and a width of the coupling depression decrease along a thickness direction from a lower surface of the elastic portion toward an upper surface of the seating portion.

6. The display device of claim 1, wherein the elastic portion is spaced apart from each of the end portion of the diffusion plate and an end portion of the optical sheet in at least one of a first direction and a second direction different from the first direction.

7. The display device of claim 6, wherein a distance between the elastic portion and the diffusion plate is different from a distance between the elastic portion and the optical sheet.

8. The display device of claim 1, wherein the diffusion plate is spaced apart from the display panel by the elastic portion in a third direction.

9. The display device of claim 1, wherein the elastic portion defines a guide depression for accommodating a part of the optical sheet.

10. The display device of claim 9, wherein a thickness of the side end portion of the elastic portion decreases along a direction from the accommodated end portion of the diffusion plate toward a center portion of the diffusion plate in an area corresponding to the guide depression.

11. The display device of claim 9, wherein the optical sheet comprises a protruding portion disposed at the guide depression.

12. The display device of claim 11, wherein the elastic portion comprises a projection disposed on the guide depression, and
the protruding portion of the optical sheet defines one of a through hole and a cutout portion for accommodating the projection.

13. The display device of claim 9, further comprising an adhesive tape that covers the guide depression of the elastic portion.

14. The display device of claim 13, wherein the elastic portion defines a step depression for accommodating the adhesive tape.

15. The display device of claim 14, wherein a thickness of the adhesive tape is substantially equal to a thickness of the step depression.

16. The display device of claim 1, wherein the elastic portion further comprises a buffer portion having a hollow structure.

17. A display device comprising:
a display panel having a display area and a non-display area; and
a backlight unit disposed below the display panel,
wherein the backlight unit comprises:
a bottom cover comprising a bottom portion and a side wall protruding from the bottom portion;
a light source accommodated in the bottom cover;
a middle mold supported by the bottom cover, the middle mold comprising a seating portion and an elastic portion mounted on the seating portion;
a diffusion plate supported by the elastic portion; and
an optical sheet disposed on the elastic portion,
the elastic portion has a guide depression for accommodating a part of the optical sheet, and
the optical sheet comprises a protruding portion disposed at the guide depression.

18. The display device of claim 17, wherein the elastic portion comprises a projection disposed on the guide depression, and
the protruding portion of the optical sheet defines one of a through hole and a cutout portion for accommodating the projection.

19. The display device of claim 18, further comprising an adhesive tape that covers the guide depression of the elastic portion.

20. The display device of claim 19, wherein the elastic portion defines a step depression for accommodating the adhesive tape.

21. The display device of claim 20, wherein a thickness of the adhesive tape is substantially equal to a thickness of the step depression.

22. The display device of claim 17, wherein the diffusion plate comprises a glass plate, a wavelength conversion layer disposed at an upper surface of the glass plate, a passivation layer disposed on the wavelength conversion layer, and a diffusion pattern disposed at a lower surface of the glass plate.

23. The display device of claim 17, wherein the optical sheet has a thickness less than a thickness of the diffusion plate.

24. The display device of claim 17, wherein the optical sheet has a thickness greater than a thickness of the diffusion plate at an area corresponding to the protruding portion.

25. The display device of claim 17, wherein the optical sheet contacts the diffusion plate at the display area.
